(19) United States
(12) Patent Application Publication
(10) Pub. No.: US 2026/0334549 A1
(43) Pub. Date: Oct. 29, 2026

(54) HEATER ASSEMBLY HAVING SEPARATED SEALING ELEMENTS

(71) Applicant: Philip Morris Products S.A., Neuchatel (CH)

(72) Inventors: Guo YU, Shenzhen (CN); Lizhang YANG, Shenzhen (CN)

(73) Assignee: Philip Morris Products S.A., Neuchatel (CH)

(21) Appl. No.: 19/099,674

(22) PCT Filed: Aug. 24, 2022
(86) PCT No.: PCT/CN2022/114583

§ 371 Date: Jan. 29, 2025

(51) Int. Cl. A24F 40/46; A24F 40/485; H05B 3/06

(52) U.S. Cl. CPC A24F 40/46; A24F 40/485; H05B 3/06

(57) ABSTRACT

A heater assembly for an aerosol-generating device is provided, the heater assembly including: a first heater casing including an air inlet; a second heater casing including an aerosol outlet; a tubular heater configured to heat an aerosol-forming substrate; an airflow pathway extending through the heater assembly from the air inlet to the aerosol outlet, the airflow pathway passing through the first heater casing, the tubular heater, and the second heater casing; a first sealing element configured to seal the first heater casing to the tubular heater; and a second sealing element configured to seal the second heater casing to the tubular heater, the first and the second sealing elements being separated from the airflow pathway.

The present disclosure relates to a heater assembly for an aerosol-generating device. The present disclosure further relates to an aerosol-generating device comprising a heater assembly. In particular, but not exclusively, the present disclosure relates to a handheld electrically operated aerosol-generating device for heating an aerosol-forming substrate to generate an aerosol and for delivering the aerosol into the mouth of a user. The present disclosure also relates to an aerosol-generating system comprising an aerosol-generating device and an aerosol-forming substrate.

Aerosol generating devices which heat an aerosol-forming substrate to produce an aerosol without burning the aerosol-forming substrate are known in the art. The aerosol-forming substrate is typically provided within an aerosol-generating article, together with other components such as filters. The aerosol-generating article may have a rod shape for insertion of the aerosol-generating article into a heating chamber of the aerosol-generating device. A heating element is typically arranged in or around the heating chamber for heating the aerosol-forming substrate once the aerosol-generating article is inserted into the heating chamber of the aerosol-generating device.

The heating chamber may be arranged within a housing of the aerosol-generating device and form part of an airflow pathway through the aerosol-generating device. One method of attaching the heating chamber to the housing of the aerosol-generating device is by mechanical press-fitting. However, due to manufacturing tolerances, it is difficult to achieve an air tight seal between the housing and the heating chamber with mechanical press-fitting and gaps can remain between the housing and heating chamber through which aerosol can escape from the heating chamber and the airflow pathway into the portion of the housing surrounding the heating chamber. The aerosol that escapes may condense in the portion of the housing surrounding the heating chamber and form a slurry. When a consumer uses the aerosol-generating device the slurry may be repeatedly heated, which may produce undesirable by-products. These by-products may enter the airflow pathway via the gaps between the housing and the heating chamber and adversely affect the consumer's experience of using the aerosol-generating device.

Furthermore, gaps between the housing and heating chamber may result in heat being lost from the heating chamber which may reduce the thermal efficiency of the device and the heat available for heating the aerosol-forming substrate. This may also degrade the consumer experience.

It would be desirable to provide a heater assembly for an aerosol-generating device having improved sealing of its airflow pathway. It would be desirable to provide a heater assembly for an aerosol-generating device which is more energy efficient and improves the delivery of aerosol to a user.

According to an example of the present disclosure, there is provided a heater assembly for an aerosol-generating device. The heater assembly may comprise a first heater casing. The first heater casing may comprise an air inlet. The heater assembly may comprise a second heater casing. The second heater casing may comprise an aerosol outlet. The heater assembly may comprise a tubular heater for heating an aerosol-forming substrate to generate an aerosol. The heater assembly may comprise an airflow pathway. The airflow pathway may extend through the heater assembly from the air inlet to the aerosol outlet. The airflow pathway may pass through the first heater casing. The airflow pathway may pass through the tubular heater. The airflow pathway may pass through the second heater casing. The heater assembly may comprise a first sealing element. The first sealing element may be configured to seal the first heater casing to the tubular heater. The heater assembly may comprise a second sealing element. The second sealing element may be configured to seal the second heater casing to the tubular heater. The first sealing element may be separated from the airflow pathway. The second sealing element may be separated from the airflow pathway.

According to an example of the present disclosure, there is provided a heater assembly for an aerosol-generating device. The heater assembly comprises: a first heater casing comprising an air inlet; a second heater casing comprising an aerosol outlet; a tubular heater for heating an aerosol-forming substrate to generate an aerosol; and an airflow pathway extending through the heater assembly from the air inlet to the aerosol outlet, the airflow pathway passing through the first heater casing, the tubular heater and the second heater casing. The heater assembly further comprising a first sealing element configured to seal the first heater casing to the tubular heater; and a second sealing element configured to seal the second heater casing to the tubular heater. The first and second sealing elements are separated from the airflow pathway.

Advantageously, the first and second sealing elements provide a seal around the tubular heater. This helps inhibit leakage of the aerosol from the tubular heater into the first and second heater casings, which reduces the likelihood of a slurry forming in the first and second heater casings and the generation of unwanted by-products. Furthermore, the first and second sealing elements are separated from the airflow pathway which inhibits contact between the heated aerosol and air and the sealing element. This helps to reduce the likelihood of the sealing elements being degraded by the aerosol and potentially releasing unwanted by-products. Furthermore, the sealing elements restrict unwanted by-products from entering the aerosol or airflow in the airflow pathway. In addition, the first and second sealing elements are separated from the airflow pathway to inhibit contact between the aerosol and the first and second sealing elements. This helps to prevent the aerosol from degrading the sealing elements and reduce the likelihood of any substances released from the sealing elements from entering the airflow pathway. Another advantage of the first and second sealing elements providing a seal around the tubular heater is that it helps to reduce leakage of heated aerosol and air from the tubular heater, which improves the energy efficiency of the heater assembly.

As used herein, when defining the location of the first and second sealing elements relative to the airflow pathway, the term “separated” means that there is a physical barrier between the sealing elements and the airflow pathway. For example, the tubular heater may act as a physical barrier between the first and second sealing elements and the airflow pathway, that is, a wall of the tubular heater may be arranged between the first and second sealing elements and the airflow pathway. In addition, the first and second heater casings or the interface between the first and second heater casings and the tubular heater may act as a physical barrier between the first and second sealing elements and the airflow pathway.

The first sealing element may comprise an annular seal. The first sealing element may be arranged between an inner surface of the first heater casing and an outer surface of the tubular heater. Advantageously, in this arrangement, the first sealing element is placed on the opposite side of the tubular heater to that where the airflow pathway is passing such that the tubular heater acts as a physical barrier between the first sealing element and the airflow pathway.

The second sealing element may comprise an annular seal. The second sealing element may be arranged between an inner surface of the second heater casing and an outer surface of the tubular heater. Advantageously, in this arrangement, the second sealing element is placed on the opposite side of the tubular heater to that where the airflow pathway is passing such that the tubular heater acts as a physical barrier between the second sealing element and the airflow pathway.

At least one of the first and second sealing elements may be arranged in a groove or recess formed in an inner surface of a respective one of the first and second heater casings. The first sealing element may be arranged in a groove or recess formed in an inner surface of the first heater casing. The second sealing element may be arranged in a groove or recess formed in an inner surface of the second heater casing. A first end of the tubular heater may be arranged in the grove or recess formed in an inner surface of the first heater casing. A second end of the tubular heater may be arranged in the grove or recess formed in an inner surface of the second heater casing. Advantageously, a groove provides an effective way of holding a sealing element in place and also helps to protect the sealing element. Advantageously, the groove provides an effective way of holding the tubular heater in place.

The first heater casing may comprise a tube holder for holding the tubular heater. The airflow pathway may pass through the tube holder. A tube holder provides an effective way of holding or supporting the tubular heater. A tube holder also helps to distance the tubular heater from the remainder of the first heater casing to thermally insulate or isolate the remainder of the first heater casing from the relatively high temperatures reached by the tubular heater.

The first sealing element may be arranged between the tube holder and an outer surface of the tubular heater. This arrangement helps to seal the tube holder component of the first heater casing to the tubular heater.

The first and second sealing elements may comprise opposing end sections of the tubular heater. The opposing end sections may be fixed in sealing engagement to the inner surfaces of the first and second heater casings. Advantageously, in this arrangement, the interface between the first and second heater casings and the tubular heater acts as a physical barrier between the first and second sealing elements and the airflow pathway. That is, the sealing engagement of the opposing end sections of the tubular heater with the inner surfaces of the first and second heater casings helps to seal the airflow pathway and protect the opposing end sections.

The opposing end sections of the tubular heater may be fixed in sealing engagement within grooves or recesses formed in the inner surfaces of the first and second heater casings. Advantageously, in this arrangement, the parts of the first and second heater casings around the grooves or recesses act as a physical barrier between the opposing end sections of the tubular heater and the airflow pathway so that aerosol cannot contact the sealing elements.

The opposing end sections of the tubular heater may be embedded in the inner surfaces of the first and second heater casings. Advantageously, in this arrangement, the parts of the first and second heater casings around the embedded opposing end section of the tubular heater act as a physical barrier between the opposing end sections of the tubular heater and the airflow pathway so that aerosol cannot contact the sealing elements.

The first and second heater casings may be sealed or connected to the opposing end sections of the tubular heater by one or more of the following processes insert moulding, over moulding, hot-melting, high frequency welding and ultrasonic welding.

The opposing end sections of the tubular heater have a surface finish with an ISO roughness value in the range N9 to N12. The surface roughness may be determined in accordance with the specification for surface roughness set out in ISO standard 1302 and, in particular, ISO standard 1302:1992. The surface roughness of the opposing end sections can be created by any suitable manufacturing or machining process including, but not limited to, abrading, casting, coating, cutting, etching, plastic deformation, sintering, wear and erosion.

In arrangements in which the first and second sealing elements comprise opposing end sections of the tubular heater, the heater assembly may further comprise a third sealing element configured to further seal the first heater casing to the tubular heater. The heater assembly may further comprise a fourth sealing element configured to further seal the second heater casing to the tubular heater. Advantageously, this arrangement helps to provide a further degree of sealing of the airflow pathway.

The third sealing element may comprise an annular seal. The third sealing element may be arranged between an inner surface of the first heater casing and an outer surface of the tubular heater. Advantageously, in this arrangement, the third sealing element is placed on the opposite side of the tubular heater to that where the airflow pathway is passing such that the tubular heater acts as a physical barrier between the third sealing element and the airflow pathway.

The fourth sealing element may comprise an annular seal. The fourth sealing element may be arranged between an inner surface of the second heater casing and an outer surface of the tubular heater. Advantageously, in this arrangement, the fourth sealing element is placed on the opposite side of the tubular heater to that where the airflow pathway is passing such that the tubular heater acts as a physical barrier between the fourth sealing element and the airflow pathway.

In one example, the tubular heater may be enclosed by the first and second heater casings. Advantageously, this arrangement may help to inhibit aerosol from leaking out of the airflow pathway into the aerosol-generating device.

In another example, the heater assembly may further comprise a heater sleeve surrounding at least a portion of the tubular heater, the heater sleeve being arranged between the first and second heater casings. The heater sleeve may help to inhibit aerosol from leaking out of the airflow pathway into the aerosol-generating device.

The first sealing element may engage an inner surface of the first heater casing, an outer surface of the tubular heater and an inner or end surface of the heater sleeve. This arrangement may help to provide sealing engagement between the first heater casing, the tubular heater and the heater sleeve to seal the airflow pathway.

The second sealing element may engage an inner surface of the second heater casing, an outer surface of the tubular heater and an inner or end surface of the heater sleeve. This arrangement may help to provide sealing engagement between the second heater casing, the tubular heater and the heater sleeve to seal the airflow pathway.

The first and second heater casings may be radially spaced from the tubular heater to define a hollow airspace around the tubular heater. Advantageously, the hollow airspace helps to thermally insulate the tubular heater which helps to reduce heat losses from the tubular heater and also helps to reduce heat transfer to an exterior of the heater assembly.

The first and second heater casings may be made from any suitable material. Preferably, the first and second heater casings are made from a heat resistant plastic capable of withstanding a temperature of at least 250 degrees centigrade, preferably at least 300 degrees centigrade and more preferably at least 350 degrees centigrade. In an one example, the first and second heater casings may be made from polyetheretherketone (PEEK). Such a material is a good thermal insulator and helps to reduce the transfer of heat out of the heater assembly.

A diameter of the tubular heater at a first end of the tubular heater may be greater than a diameter along the length of the tubular heater. A diameter of the tubular heater at a second end of the tubular heater may be greater than a diameter along the length of the tubular heater. A diameter of the tubular heater at each end of the tubular heater may be greater than a diameter of the tubular heater in a region between the two ends of the tubular heater. An advantage of making the diameter of one or both ends of the tubular heater greater than the diameter of the tubular heater along the length of the tubular heater, for example, in the region between the two ends of the tubular heater, is that it allows for greater manufacturing tolerances for the tubular heater and also for the other components of the heater assembly. This may help in the assembly of the heater assembly and also reduce the number of machining or finishing steps required during manufacture of the tubular heater.

Another advantage of making an end diameter of the tubular heater greater than other parts of the tubular heater is that the internal diameter at one or both ends of the tubular heater will be greater than the internal diameter of the airflow pathway in other components of the heater assembly that the tubular heater engages, for example, the first and second heater casings. This helps to avoid an end surface of the tubular heater protruding or encroaching into the internal space of the airflow pathway, which can potentially cause damage to the aerosol-generating article when it is received into the tubular heater.

An external diameter of one or both ends of the tubular heater may be up to 40 percent larger, preferably up to 35 percent larger, more preferably up to 30 percent larger, and even more preferably up to 27 percent larger than an external diameter of a portion of the tubular heater between the two ends of the tubular heater. The external diameter of one or both ends of the tubular heater may be between 10 percent and 40 percent larger, between 15 percent and 35 percent larger, between 20 percent and 30 percent larger, or between 25 percent and 30 percent larger than an external diameter of a portion of the tubular heater between the two ends of the tubular heater.

One or both ends of the tubular heater may have an external diameter of between about 7.6 millimetres and about 10.7 millimetres, preferably between about 9.0 millimetres and about 10.0 millimetres and more preferably about 9.7 millimetres. A portion of the tubular heater between the two ends of the tubular heater may have an external diameter of between about 6.5 millimetres and about 8.0 millimetres, preferably between about 7.0 millimetres and about 8.0 millimetres and more preferably about 7.6 millimetres.

An internal diameter of the tubular heater between the two ends of the tubular heater may substantially correspond, or be substantially equal, to an external diameter of an aerosol-generating article. In some embodiments, an internal diameter of the tubular heater may be slightly smaller than the external diameter of an aerosol-generating article, such that the aerosol-generating article is compressed in the tubular heater. For example, the external diameter of an aerosol-generating article may be about 7.4 millimetres, and the internal diameter of the tubular heater may be about 7.3 millimetres. A length of the tubular heater may substantially correspond, or be substantially equal, to a length of an aerosol-forming substrate provided in an aerosol-generating article.

A portion of a first end of the tubular heater may be flared or funnel-shaped. A portion of a second end of the tubular heater may be flared or funnel-shaped. A portion of each end of the tubular heater may be flared or funnel-shaped. The axial length of each portion of each end of the tubular heater that is flared or funnel-shaped may be between 3.5 percent and 15 percent of the overall length of the tubular heater, preferably between 5 percent and 10 percent of the overall length of the tubular heater and more preferably about 8 percent of the overall length of the tubular heater. The flared or funnel-shaped end portion or end portions of the tubular heater may be arranged at an angle between 30 and 60 degrees, between 40 and 50 degrees, or at an angle of about 45 degrees to the longitudinal axis of the tubular heater or heater assembly.

Advantageously, a flared or funnel-shaped portion of the tubular heater is a convenient way of providing a tubular heater having a diameter at one or both ends that is be greater than a diameter of the tubular heater in a region between the two ends of the tubular heater. Furthermore, a flared or funnel-shaped portion of the tubular heater provides a smooth transition between the larger and smaller diameter which helps assists with insertion of an aerosol-generating article into the tubular heater. In addition, a flared or funnel-shaped portion of the tubular heater provides improved sealing of the airflow pathway.

In arrangements in which the tubular heater has flared or funnel-shaped end portions and in which the first and second sealing elements comprise opposing end sections of the tubular heater, the first and second sealing elements may comprise elongated sections at each end of the tubular heater that extend in a direction parallel to the longitudinal axis of the tubular heater. Each elongate section of the tubular heater may have a length of between 1 and 2 millimetres and preferably of about 1.5 mm. The length of each elongated section may be between 3.5 percent and 15 percent of the overall length of the tubular heater, preferably between 7 percent and 12 percent of the overall length of the tubular heater and more preferably about 9 percent of the overall length of the tubular heater.

The tubular heater may be made from any suitable material including, but not limited to, a ceramic or metal or metal alloy. An example of a suitable material is stainless steel.

The heater assembly may comprise at least one electric heating element for heating an aerosol-forming substrate. The heater assembly may comprise a plurality of electric heating elements. The electric heating element or elements may be arranged around or circumscribe an external surface of the tubular heater. The electric heating element or elements may be arranged around or circumscribe an internal surface of the tubular heater. The electric heating element or elements may be part of, or integral to, the tubular heater.

The electric heating element or elements may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold-and iron-containing alloys, and super-alloys based on nickel, iron, cobalt, stainless steel, Timetal™, Kanthal™ and other iron-chromium-aluminium alloys, and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The one or more heating elements may be formed using a metal or metal alloy having a defined relationship between temperature and resistivity. Heating elements formed in this manner may be used to both heat and monitor the temperature of the heating element during operation.

The heating element may be deposited in or on a rigid carrier material or substrate. The heating element may be deposited in or on a flexible carrier material or substrate. The heating element may be formed as a track on a suitable insulating material, such as ceramic or glass or polyimide film. The heating element may be sandwiched between two insulating materials.

The heater assembly may comprise a flexible heating element arranged around or circumscribing an external surface of the tubular heater. The flexible heating element may have a length substantially equal to the length of the aerosol-forming substrate provided in the aerosol-generating article.

The tubular heater may be configured to receive at least a portion of an aerosol-generating article (as defined below).

According to an example of the present disclosure, there is provided an aerosol-generating device. The aerosol-generating device may comprise a heater assembly according to any of the heater assemblies described above. The aerosol-generating device may comprise a power supply for supplying electrical power to the heater assembly.

According to an example of the present disclosure, there is provided an aerosol-generating device. The aerosol-generating device comprises a heater assembly according to any of the heater assemblies described above. The aerosol-generating device comprises a power supply for supplying electrical power to the heater assembly.

The power supply may be any suitable power supply, for example a DC voltage source. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate or a Lithium-Polymer battery.

The aerosol-generating device is preferably a handheld aerosol-generating device that is comfortable for a user to hold between the fingers of a single hand.

The aerosol-generating device may further comprise control circuitry configured to control a supply of electrical power to the heater assembly. The control circuitry may comprise a microprocessor. The microprocessor may be a programmable microprocessor, a microcontroller, or an application specific integrated chip (ASIC) or other electronic circuitry capable of providing control. The control circuitry may comprise further electronic components. For example, in some embodiments, the control circuitry may comprise any of: sensors, switches, display elements. Power may be supplied to the heater assembly continuously following activation of the device or may be supplied intermittently, such as on a puff-by-puff basis. The power may be supplied to the heater assembly in the form of pulses of electrical current, for example, by means of pulse width modulation (PWM).

The aerosol-generating device may comprise a device housing. The device housing may contain the heater assembly, power supply and control circuitry. The housing may comprise an opening for receiving an aerosol-generating article. The opening may be connected to the aerosol outlet of the second heater casing of the heater assembly to allow for insertion of an aerosol-generating article into the tubular heater. The housing may comprising an air inlet. The air inlet may be connected to the air inlet of the first heater casing of the heater assembly.

The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

According to an example of the present disclosure, there is provided an aerosol-generating system. The aerosol-generating system may comprise an aerosol-generating device according to any of the aerosol-generating devices described above. The aerosol-generating system may comprise an aerosol-generating article comprising an aerosol-forming substrate.

According to an example of the present disclosure, there is provided an aerosol-generating system. The aerosol-generating system comprises an aerosol-generating device according to any of the aerosol-generating devices described above. The aerosol-generating system comprises an aerosol-generating article comprising an aerosol-forming substrate.

As used herein, the term “aerosol-generating article” refers to an article comprising an aerosol-forming substrate that, when heated in an aerosol-generating device, releases volatile compounds that can form an aerosol. An aerosol-generating article is separate from and configured for combination with an aerosol-generating device for heating the aerosol-generating article.

The aerosol-generating article may be substantially cylindrical in shape. The aerosol-generating article may be substantially elongate. The aerosol-forming substrate may be substantially cylindrical in shape. The aerosol-forming substrate may be substantially elongate. The aerosol-generating article may have a total length between approximately 30 mm and approximately 100 mm. The aerosol-generating article may have an external diameter between approximately 5 mm and approximately 12 mm. The aerosol-forming substrate may have a length of between approximately 10 mm and approximately 18 mm. Further, the diameter of the aerosol-forming substrate may be between approximately 5 mm and approximately 12 mm. The aerosol-generating article may comprise a filter plug. The filter plug may be located at the downstream end of the aerosol-generating article. The filter plug may be a cellulose acetate filter plug. The filter plug is approximately 7 mm in length in one embodiment, but may have a length of between approximately 5 mm to approximately 12 mm.

The terms “upstream”, “downstream”, “proximal” and “distal” are used to describe the relative positions of components, or portions of components, of an aerosol-generating device and aerosol generating article. Aerosol generating articles and devices according to the present disclosure have a proximal end through which, in use, an aerosol exits the article or device for delivery to a user, and have an opposing distal end. The proximal end of the aerosol generating article and device may also be referred to as the mouth end. In use, a user draws on the proximal end of the aerosol generating article in order to inhale an aerosol generated by the aerosol generating article or device. The terms upstream and downstream are relative to the direction of aerosol movement through the aerosol generating article or aerosol-generating device when a user draws on the proximal end of the aerosol-generating article. The proximal end of the aerosol-generating article is downstream of the distal end of the aerosol-generating article. The proximal end of the aerosol-generating article may also be referred to as the downstream end of the aerosol-generating article and the distal end of the aerosol-generating article may also be referred to as the upstream end of the aerosol-generating article.

In one embodiment, the aerosol-generating article may have a total length of approximately 45 mm. The aerosol-generating article may have an external diameter of approximately 7.3 mm but may have an external diameter of between approximately 7.0 mm and approximately 7.4 mm. Further, the aerosol-forming substrate may have a length of approximately 12 mm. Alternatively, the aerosol-forming substrate may have a length of approximately 16 mm. The aerosol-generating article may comprise an outer paper wrapper. Further, the aerosol-generating article may comprise a separation between the aerosol-forming substrate and the filter plug. The separation may be approximately 21 mm or approximately 26 mm, but may be in the range of approximately 5 mm to approximately 28 mm. The separation may be provided by a hollow tube. The hollow tube may be a made from cardboard or cellulose acetate.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise comminuting one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

In a particularly preferred embodiment, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

Although reference is made to solid aerosol-forming substrates above, it will be clear to one of ordinary skill in the art that other forms of aerosol-forming substrate may be used with other embodiments. For example, the aerosol-forming substrate may be a liquid aerosol-forming substrate. If a liquid aerosol-forming substrate is provided, the aerosol-generating device preferably comprises means for retaining the liquid. For example, the liquid aerosol-forming substrate may be retained in a container or a liquid storage portion. Alternatively or in addition, the liquid aerosol-forming substrate may be absorbed into a porous carrier material. The porous carrier material may be made from any suitable absorbent plug or body, for example, a foamed metal or plastics material, polypropylene, terylene, nylon fibres or ceramic. The liquid aerosol-forming substrate may be retained in the porous carrier material prior to use of the aerosol-generating device or alternatively, the liquid aerosol-forming substrate material may be released into the porous carrier material during, or immediately prior to use. For example, the liquid aerosol-forming substrate may be provided in a capsule. The shell of the capsule preferably melts upon heating and releases the liquid aerosol-forming substrate into the porous carrier material. The capsule may optionally contain a solid in combination with the liquid.

Alternatively, the carrier may be a non-woven fabric or fibre bundle into which tobacco components have been incorporated. The non-woven fabric or fibre bundle may comprise, for example, carbon fibres, natural cellulose fibres, or cellulose derivative fibres.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.
Example Ex1: A heater assembly for an aerosol-generating device, the heater assembly comprising: a heating chamber for heating an aerosol-forming substrate; an air inlet and an aerosol outlet; wherein an airflow pathway extends through the heater assembly from the air inlet to the aerosol outlet, the airflow pathway passing through the heating chamber.
Example Ex2: A heater assembly according to Example Ex1, further comprising a first heater casing, wherein the first heater casing comprises the air inlet.
Example Ex3: A heater assembly according to any of Examples Ex1 or Ex2, further comprising a second heater casing, wherein the second heater casing comprises the aerosol outlet.
Example Ex4: A heater assembly according to any of Examples Ex1 to Ex3, further comprising a first sealing element configured to seal the first heater casing to the heating chamber.
Example Ex5: A heater assembly according to any of Examples Ex1 to Ex4, further comprising a second sealing element configured to seal the second heater casing to the heating chamber.
Example Ex6: A heater assembly according to Example Ex5, wherein the first and second sealing elements are separated from the airflow pathway.
Example Ex7: A heater assembly according to any of Examples Ex3 to Ex6, wherein the airflow pathway passes through the first heater casing, the heating chamber and the second heater casing
Example Ex8: A heater assembly according to any of Examples Ex4 to Ex7, wherein the first sealing element comprises an annular seal and is arranged between an inner surface of the first heater casing and an outer surface of the heating chamber.
Example Ex9: A heater assembly according to any of Examples Ex5 to Ex8, wherein the second sealing element comprises an annular seal and is arranged between an inner surface of the second heater casing and an outer surface of the heating chamber.
Example Ex10: A heater assembly according to any of Examples Ex5 to Ex9, wherein at least one of the first and second sealing elements is arranged in a groove or recess formed in an inner surface of a respective one of the first and second heater casings.
Example Ex11: A heater assembly according to any of Examples Ex2 to Ex10, wherein the first heater casing comprises a holder for holding the heating chamber, the airflow pathway passing through the holder.
Example Ex12: A heater assembly according to Example Ex11, wherein the first sealing element is arranged between the holder and an outer surface of the heating chamber.
Example Ex13: A heater assembly according to Example Ex5, wherein the first and second sealing elements comprise opposing end sections of the heating chamber, the opposing end sections being fixed in sealing engagement to the inner surfaces of the first and second heater casings.
Example Ex14: A heater assembly according to Example Ex13, wherein the opposing end sections of the heating chamber are fixed in sealing engagement within grooves or recesses formed in the inner surfaces of the first and second heater casings.
Example Ex15: A heater assembly according to Example Ex13, wherein the opposing end sections of the heating chamber are embedded in the inner surfaces of the first and second heater casings.
Example Ex16: A heater assembly according to any of Examples Ex13 to Ex15, wherein the opposing end sections extend in a direction parallel to the longitudinal axis of the heating chamber for a length between 5 percent and 15 percent of the overall length of the heating chamber.
Example Ex17: A heater assembly according to Example Ex13, wherein the opposing end sections of the heating chamber have a surface finish with an ISO roughness value in the range N9 to N12.
Example Ex18: A heater assembly according to any of Examples Ex13 to Ex17, further comprising a third sealing element configured to further seal the first heater casing to the heating chamber.
Example Ex19: A heater assembly according to any of Examples Ex13 to Ex18, further comprising a fourth sealing element configured to further seal the second heater casing to the heating chamber.
Example Ex20: A heater assembly according to Example Ex18 or Ex19, wherein the third sealing element comprises an annular seal and is arranged between an inner surface of the first heater casing and an outer surface of the heating chamber.
Example Ex21: A heater assembly according to any of Examples Ex18 to Ex20, wherein the fourth sealing element comprises an annular seal and is arranged between an inner surface of the second heater casing and an outer surface of the heating chamber.
Example Ex22: A heater assembly according to any of Examples Ex3 to Ex21, wherein the heating chamber is enclosed by the first and second heater casings.
Example Ex23: A heater assembly according to any of Examples Ex3 to Ex21, further comprising a heater sleeve surrounding at least a portion of the heating chamber, the heater sleeve being arranged between the first and second heater casings.
Example Ex24: A heater assembly according to Example Ex23, wherein the first sealing element engages an inner surface of the first heater casing, an outer surface of the heating chamber and an inner or end surface of the heater sleeve.
Example Ex25: A heater assembly according to Example Ex23 or Ex24, wherein the second sealing element engages an inner surface of the second heater casing, an outer surface of the heating chamber and an inner or end surface of the heater sleeve.
Example Ex26: A heater assembly according to any of Examples Ex1 to Ex25, wherein a diameter of the heating chamber at each end of the heating chamber is greater than a diameter of the heating chamber in a region between the two ends of the heating chamber.
Example Ex27: A heater assembly according to Example Ex26, wherein a portion of each end of the heating chamber is flared or funnel-shaped.
Example Ex28: A heater assembly according to Example Ex27, wherein an axial length of the flared or funnel-shaped end of the heating chamber is between 5 percent and 15 percent of the overall length of the heating chamber.
Example Ex29: A heater assembly according to any of Examples Ex1 to Ex28, wherein the heating chamber comprises a tubular heater.
Example Ex30: An aerosol-generating device comprising: a heater assembly according to any of Examples Ex1 to Ex29; and a power supply for supplying electrical power to the heater assembly.
Example Ex31: An aerosol-generating system comprising: an aerosol-generating device according to Example Ex30; and an aerosol-generating article comprising an aerosol-forming substrate.

Examples will now be further described with reference to the figures in which:

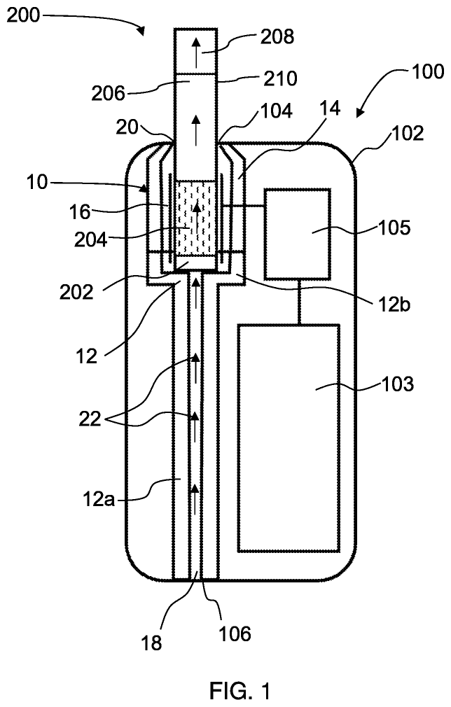

FIG. 1 is a schematic cross-sectional view showing the interior of an aerosol-generating device according to an example of the present disclosure and an aerosol-generating article received within the aerosol-generating device.

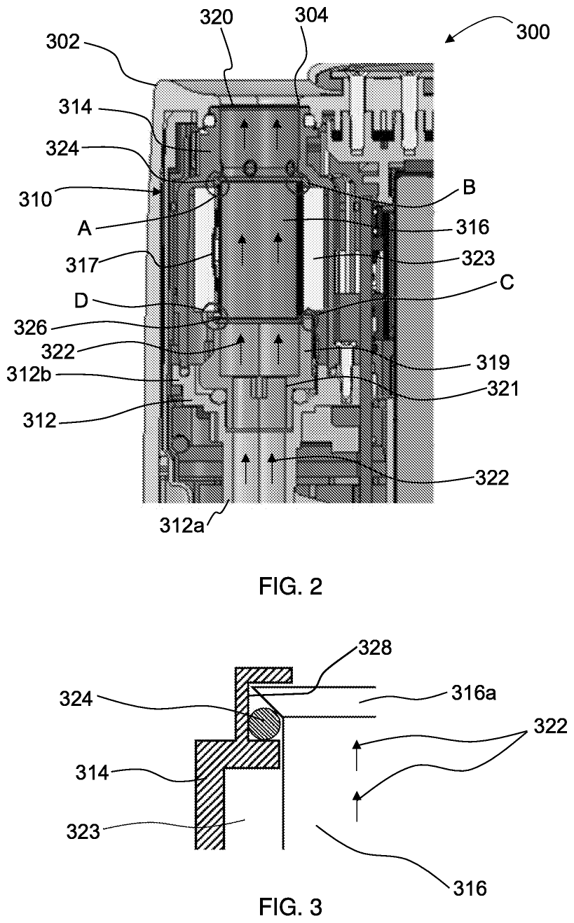

FIG. 2 is a cross-sectional view of part of an aerosol-generating device having a heater assembly according to an example of the present disclosure.

FIG. 3 is an enlarged schematic cross-sectional view of the seal arrangement labelled A in FIG. 2.

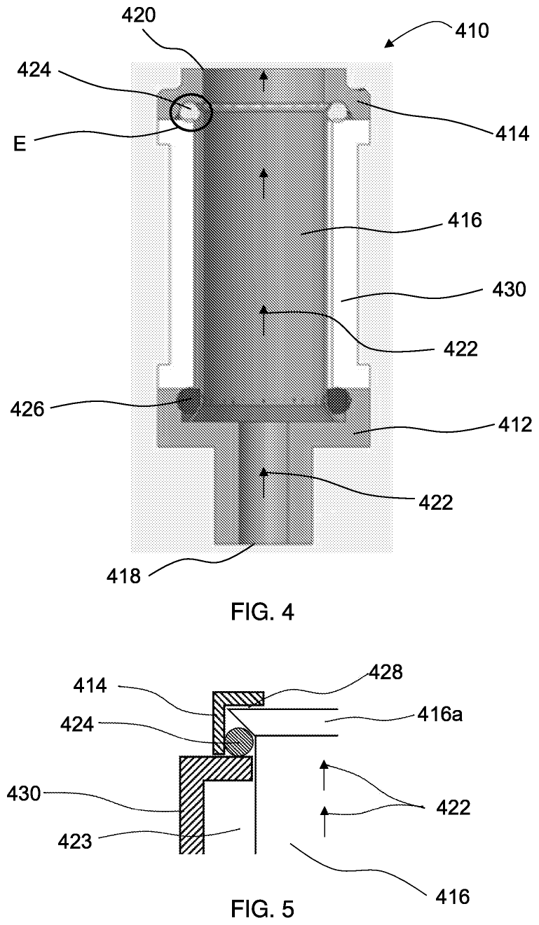

FIG. 4 is a cross-sectional view of a heater assembly according to another example of the present disclosure.

FIG. 5 is an enlarged schematic cross-sectional view of the seal arrangement labelled E in FIG. 4.

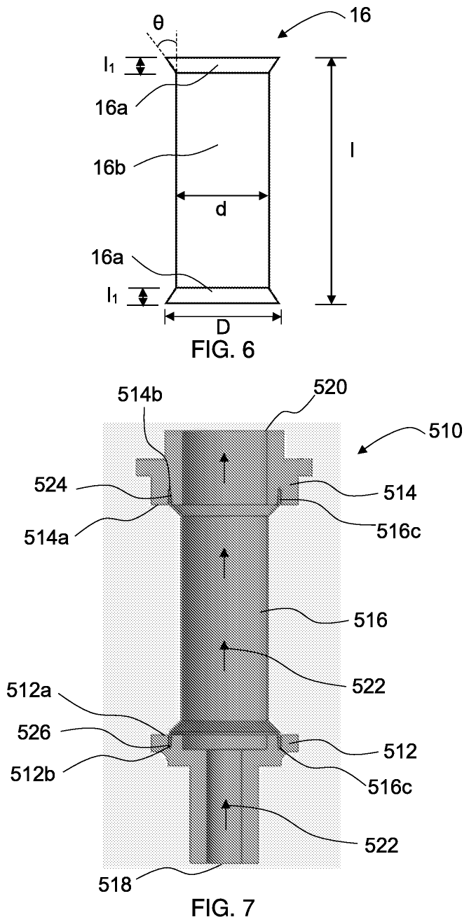

FIG. 6 is a side view of an example tubular heater for use in a heater assembly according to the present disclosure.

FIG. 7 is a cross-sectional view of a heater assembly according to another example of the present disclosure.

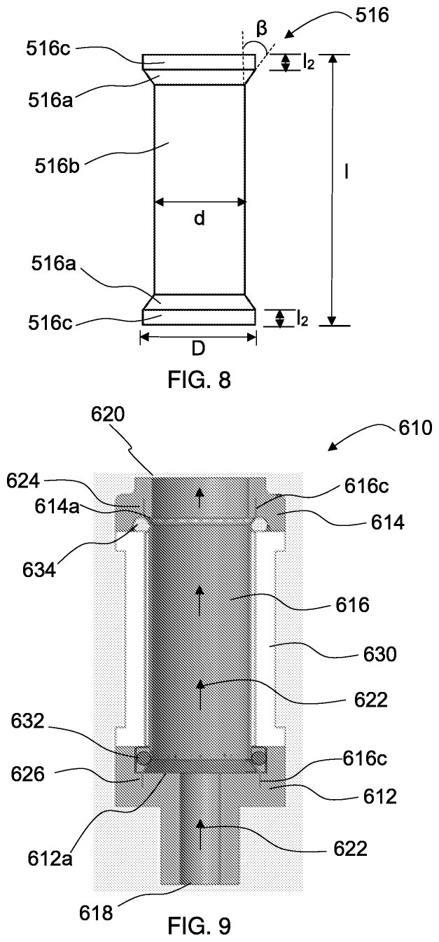

FIG. 8 is a side view of another example tubular heater for use in a heater assembly according to the present disclosure.

FIG. 9 is a cross-sectional view of a heater assembly according to another example of the present disclosure.

Referring to FIG. 1, this shows a schematic cross-sectional view of the interior of an aerosol-generating device 100 and an aerosol-generating article 200 received within the aerosol-generating device 100. Together, the aerosol-generating device 100 and aerosol-generating article 200 form an aerosol-generating system. In FIG. 1, the aerosol-generating device 100 is shown in a simplified manner. In particular, the elements of the aerosol-generating device 100 are not drawn to scale. Furthermore, elements that are not relevant for the understanding of the aerosol-generating device 100 have been omitted.

The aerosol-generating device 100 comprises a housing 102 containing a heater assembly 10, a power supply 103 and control circuitry 105. The heater assembly 10 comprises a first heater casing 12, a second heater casing 14 and a tubular heater 16 for heating an aerosol-forming substrate. The tubular heater 16 defines, at least in part, a cavity for receiving a portion of the aerosol-generating article 200 and has a flexible heating element (not shown) arranged around its outer surface for heating the tubular heater 16 and, in turn, the aerosol-generating article 200. The power supply 103 comprises a battery and, in this example, it is a rechargeable lithium ion battery. The control circuitry 105 is connected to both the power supply 103 and the heating element (not shown) and controls the supply of electrical energy from the power supply 103 to the heating element to regulate the temperature of the heating element.

The first heater casing 12 is attached to the second heater casing 14 and together surround or enclose the tubular heater 16 to inhibit aerosol generated within the tubular heater 16 from leaking into the aerosol-generating device 100. The heater assembly 10 further comprises a first sealing element (now shown in FIG. 1) configured to seal the first heater casing 12 to the tubular heater 16 and a second sealing element (not shown in FIG. 1) configured to seal the second heater casing 14 to the tubular heater 16. The first and second sealing elements help to further inhibit leakage of aerosol from the tubular heater 16 into the aerosol-generating device 100 and various sealing arrangements are discussed in more detail below.

The first heater casing 12 comprises an air channel section 12a and a support section 12b. The air channel section 12a extends parallel to an longitudinal axis of the aerosol-generating device 100 from a distal end of the aerosol-generating device 100 to the support section 12b. The support section 12b is configured to support the tubular heater 16 and be attached to the second heater casing 14. An air inlet 18 is arranged at a distal end of the air channel section 12a of the first heater casing 12. The air inlet 18 is connected to an opening 106 formed at a distal end of the housing 102. Air can enter the aerosol-generating device 10 via the opening 106 and air inlet 18 and flow via the air channel section 12a to the tubular heater 16.

An aerosol outlet 20 is arranged at a proximal end of the second heater casing 14. The aerosol outlet 20 is connected to an opening 104 formed at a proximal end of the housing 102. The opening 104 is also connected to the interior of the tubular heater 16 and the aerosol-generating article 200 can be received into the tubular heater 16 via through the opening 104. The aerosol-generating article 200 is longer than the cavity defined in part by the tubular heater 16 inside the aerosol-generating device 100 and therefore a proximal or mouth end of the aerosol-generating article 200 protrudes from the aerosol-generating device 100 when the aerosol-generating article 200 is fully inserted.

An airflow pathway (denoted by a plurality of arrows 22 in FIG. 1) extends through the heater assembly 10 from the air inlet 18 to the aerosol outlet 20 and passes through the first heater casing 12, the tubular heater 16 and the second heater casing 14. Aerosol exits the heater assembly 10 via the aerosol outlet 20 connected to the opening 104 in the housing 102. However, it will be appreciated that, in use, aerosol largely exits the heater assembly 10 and the aerosol-generating device 100 via the aerosol-generating article 200 when an aerosol-generating article is received in the aerosol-generating device 100.

In the present example, the aerosol-generating article 200 comprises an end plug 202, an aerosol-forming substrate 204, a hollow tube 206, and a mouthpiece filter 208. Each of the aforementioned components of the aerosol-generating article 100 is a substantially cylindrical element, each having substantially the same diameter. The components are arranged sequentially in abutting coaxial alignment and are circumscribed by an outer paper wrapper 210 to form a cylindrical rod. The aerosol-forming substrate 204 is a tobacco rod or plug comprising a gathered sheet of crimped homogenised tobacco material circumscribed by a wrapper (not shown). The crimped sheet of homogenised tobacco material comprises glycerine as an aerosol-former. The end plug 202 and mouthpiece filter 208 are formed from cellulose acetate fibres. The aerosol-forming substrate 204 is arranged in the aerosol-generating article 200 such that, when the aerosol-generating article 200 is fully inserted into the aerosol-generating device 100, the aerosol-forming substrate 204 is located within the tubular heater 16 to heat the aerosol-forming substrate 204. It will be appreciated that other aerosol-generating article having different components or a different arrangement of components could also be used.

The aerosol-generating device 100 may further comprise: a sensor (not shown) for detecting the presence of the aerosol-generating article 200; a user interface (not shown) such as a button for activating the heating element; and a display or indicator (not shown) for presenting information to a user, for example, remaining battery power, heating status and error messages.

In use, a user inserts an aerosol-generating article 200 into the aerosol-generating device 100, as shown in FIG. 1. The user then starts a heating cycle by activating the aerosol-generating device 100, for example, by pressing a switch to turn the device on. In response, the control circuitry 105 controls a supply of electrical power from the power supply 103 to the heating element (not shown) to heat the heating element, which in turn heats the tubular heater 16. During a heating cycle, the heating element heats the tubular heater 16 to a predefined temperature, or to a range of predefined temperatures according to a temperature profile. A heating cycle may last for around 6 minutes. The heat from the tubular heater 16 is transferred to the aerosol-forming substrate 204 which releases volatile compounds from the aerosol-forming substrate 204. The volatile compounds form an aerosol within an aerosolisation chamber formed by the hollow tube 206. During a heating cycle, the user places the mouthpiece filter 208 of the aerosol-generating article 200 between the lips of their mouth and takes a puff or inhales on the mouthpiece filter 208. This creates a pressure drop within the aerosol-generating article 200, which is in fluid communication with the air inlet 18 and opening 106 of the aerosol-generating device 100 via the air channel section 12a of the first heater casing 12. The pressure drop causes air to be drawn into the aerosol-generating device 100 via the air inlet 18 and flow via the air channel section 12a to the aerosol-generating article 200. The air passes through the aerosol-generating article 200 entraining the aerosol generated from the aerosol-forming substrate 204, which is then drawn through the mouthpiece filter 208 into the mouth of the user.

FIG. 2 is a cross-sectional view of part of an aerosol-generating device 300 having a heater assembly 310 according to an example of the present disclosure. The aerosol-generating device 300 of FIG. 2 has a similar general configuration to the aerosol-generating device 100 of FIG. 1. The heater assembly 310 comprises a first heater casing 312, a second heater casing 314 and a tubular heater 316 for heating an aerosol-forming substrate received within the tubular heater 316. The tubular heater 316 has a flexible heating element 317 arranged around its outer surface for heating the tubular heater 316.

In the example heater assembly 310 of FIG. 2, the first heater casing comprises a tube holder 319 for holding the tubular heater 316. The tube holder 319 helps to position the tubular heater 316 within the heater assembly 310. A holder air channel 321 extends axially through the tube holder 319 to allow air to flow through the tube holder 319. The first heater casing 312 is attached to the second heater casing 314 and together the first 312 and second 314 heater casings enclose the tubular heater 316 and tube holder 319 to inhibit aerosol generated within the tubular heater 316 from leaking into the aerosol-generating device 300. The walls of the second heater casing 314 are radially spaced from the tubular heater 316 to define an airspace 323 around the tubular heater 316. The airspace 323 helps to thermally insulate the tubular heater 316 which helps to reduce heat losses from the tubular heater 316 and also helps to reduce heat transfer to an exterior of the heater assembly 310 and aerosol-generating device 300.

The first heater casing 312 comprises an air channel section 312a and a support section 312b. The support section 312b is configured to attach to the second heater casing 314. An air inlet (not shown) is arranged at a distal end of the air channel section 12a. An aerosol outlet 320 is arranged at a proximal end of the second heater casing 314 and is connected to an opening 304 formed at a proximal end of a housing 302 of the aerosol-generating device 300. An aerosol-generating article (not shown) can be received into the tubular heater 316 via through the opening 304. An airflow pathway (denoted by a plurality of arrows 322 in FIG. 2) extends through the heater assembly 310 from the air inlet (not shown) to the aerosol outlet 320 and passes through the first heater casing 312 including the tube holder 319, the tubular heater 316 and the second heater casing 314.

The heater assembly 310 further comprises a first sealing element 326 which seals the tubular heater 316 to the tube holder 319 of the first heater casing 312. The first sealing element 326 comprises an O-ring which circumscribes the tubular heater 316 near to a distal end of the tubular heater 316. The O-ring contacts an outer surface of the tubular heater 316 and the tube holder 319 of the first heater casing 312 to provide a seal between these two components that inhibits the leakage of aerosol from the tubular heater 316 into the airspace 323 surrounding the tubular heater 316 or other parts of the aerosol-generating device 300. The regions sealed by the first sealing element are shown by circles C and D in FIG. 2.

The heater assembly 310 further comprises a second sealing element 324 which seals the tubular heater 316 to the second heater casing 314. The second sealing element 324 comprises an O-ring which circumscribes the tubular heater 316 near to a proximal end of the tubular heater 316. The O-ring contacts an outer surface of the tubular heater 316 and an inner surface of the second heater casing 314 to provide a seal between these two components that inhibits the leakage of aerosol from the tubular heater 316 into the airspace 323 surrounding the tubular heater 316 or other parts of the aerosol-generating device 300. The regions sealed by the second sealing element are shown by circles A and B in FIG. 2.

The O-rings of the first 326 and second 324 sealing elements are preferably formed from a perfluoroelastomer such as FFKM due to its elastic deformability, temperature resistance and low toxicity. Suitable O-rings are Kalrez™ O-rings manufactured by DuPont. However, other suitable O-rings and materials may be used.

FIG. 3 is an enlarged schematic cross-sectional view of the encircled region labelled A in FIG. 2, which is sealed by the second sealing element 324. The tubular heater 316 has a flared proximal end 316a, as described in more detail below with respect to FIG. 6. An inner surface of the second heater casing 314 comprises a recess or groove 328 for receiving the flared proximal end 316a of the tubular heater 316. The second sealing element 324 also sits in the groove 328 and engages an inner surface of the groove 328 and an outer surface of the tubular heater 316 to inhibit aerosol leaking from tubular heater 316 into the airspace 323 between the tubular heater 316 and the second heater casing 314. The second sealing element 324 is placed on the opposite side of the tubular heater 316 to that where the airflow pathway 322 is passing through the tubular heater 316 such that the walls of the tubular heater 316 act as a physical barrier between the second sealing element 324 and the airflow pathway which keeps the second sealing element separate from the airflow pathway 322.

As described above with respect to FIG. 2, the second sealing element comprises an O-ring and circumscribes an outer surface of the tubular heater 316 in the region of the flared proximal end 316a and therefore a mirror image of FIG. 3 would be seen in the encircled region labelled B in FIG. 2. A similar grove arrangement to that shown in FIG. 3 is also provided in the tube holder 319 of the first heater casing 312 at a distal end of the tubular heater 316, that is, in the encircled regions labelled C and D in FIG. 2.

FIG. 4 is a cross-sectional view of a heater assembly 410 according to another example of the present disclosure. The heater assembly 410 of FIG. 4 has a similar general configuration to the heater assemblies 10 and 310 of FIGS. 1 and 2 respectively. The heater assembly 410 comprises a first heater casing 412, a second heater casing 414 and a tubular heater 416 for heating an aerosol-forming substrate received within the tubular heater 416. However, in the example of FIG. 4, the first heater casing 412 is not directly connected to the second heater casing 414 but instead a heater sleeve 430 is arranged between the first 412 and second 414 heater casings. The heater sleeve 430 circumferentially surrounds substantially the whole length of the tubular heater 416 except for the two ends of the tubular heater 416 which sit within the first 412 and second 414 heater casings.

Furthermore, in the example of FIG. 4, the tubular heater 416 is supported directly on top of the first heater casing 412, although a tube holder could be used if desired, as in the example of FIG. 2. An airflow pathway (denoted by a plurality of arrows 422 in FIG. 4) extends through the heater assembly 410 from an air inlet 418 at a distal end of the first heater casing 312 to an aerosol outlet 420 at proximal end of the second heater casing 414 and passes through the first heater casing 412, the tubular heater 416 and the second heater casing 414.

The heater assembly 410 further comprises a first sealing element 426 which seals the tubular heater 416 to the first heater casing 412 and heater sleeve 430. The first sealing element 326 comprises an O-ring which circumscribes the tubular heater 416 near to a distal end of the tubular heater 416. The O-ring contacts an outer surface of the tubular heater 416, an inner surface of the first heater casing 412 and a distal end surface of the heater sleeve 430 to provide a seal between these components that inhibits the leakage of aerosol from the heater assembly 410 into surrounding parts of the aerosol-generating device 300.

The heater assembly 410 further comprises a second sealing element 424 which seals the tubular heater 416 to the second heater casing 414 and heater sleeve 430. The second sealing element 324 comprises an O-ring which circumscribes the tubular heater 416 near to a proximal end of the tubular heater 416. The O-ring contacts an outer surface of the tubular heater 416, an inner surface of the second heater casing 414 and a proximal end surface of the heater sleeve 430 to provide a seal between these components that inhibits the leakage of aerosol from the heater assembly 410 into surrounding parts of the aerosol-generating device 300.

The same materials as used for the O-rings of the first 326 and second 324 sealing elements of FIG. 2 can be used for the O-rings of the first 426 and second 424 sealing elements of FIG. 4.

FIG. 5 is an enlarged schematic cross-sectional view of the encircled region labelled E in FIG. 4, which is sealed by the second sealing element 424. As in the example of FIG. 3, the tubular heater 416 of FIG. 5 has a flared proximal end 416a. An inner surface of the second heater casing 414 and a proximal end surface of the heater sleeve 430 define a recess or groove 428 for receiving the flared proximal end 416a of the tubular heater 416. The second sealing element 424 also sits in the groove 428 and engages an inner surface of the groove 428 and an outer surface of the tubular heater 416 to inhibit aerosol leaking from tubular heater 416 into the airspace 423 between the tubular heater 416 and the heater sleeve 430. The second sealing element 424 is placed on the opposite side of the tubular heater 416 to that where the airflow pathway 422 is passing through the tubular heater 416 such that the walls of the tubular heater 416 act as a physical barrier between the second sealing element 424 and the airflow pathway 422 which keeps the second sealing element 424 separate from the airflow pathway 422. A similar grove arrangement to that shown in FIG. 5 is also provided in the first heater casing 412 at a distal end of the tubular heater 416.

FIG. 6 is a side view of an example tubular heater 16 for use in a heater assembly according to the present disclosure. The tubular heater 16 comprises a stainless steel tube having a circular cross-section. A hollow internal space within tubular heater 16 has an internal diameter substantially corresponding to an external diameter of an aerosol-generating article so that the tubular heater 16 can receive an aerosol-generating article (not shown) within the internal space. A portion 16a of the tubular heater 16 at each end of the tubular heater 16 is flared outwards to form a funnel shape at each end of the tubular heater 16. The flared portions 16a each have a length I₁ and the percentage of the overall length I of the tubular heater 16 made up by each length I₁ of the flared portions may be in the range between 5 and 15 percent. The flared end portions 16a of the tubular heater 16 each form an angle θ with the longitudinal axis of the tubular heater 16. In this example, θ is approximately 45 degrees but other suitable angles may be used. As a result of the flared end portions 16a, the external diameter D at the two ends of the tubular heater 16 is larger than the external diameter d of the tubular heater 16 in between the two flared end portions 16a.

A portion 16b of the tubular heater 16 in between the two flared end portions 16a has straight sides, which are parallel to the longitudinal axis of the tubular heater 16. The straight portion 16b of the tubular heater 16 has a length that substantially corresponds to the length of an aerosol-forming substrate provided in an aerosol-generating article configured to be received within the tubular heater 16.

FIG. 7 is a cross-sectional view of a heater assembly 510 according to another example of the present disclosure. The heater assembly 510 comprises a first heater casing 512, a second heater casing 514 and a tubular heater 516 for heating an aerosol-forming substrate received within the tubular heater 516. The tubular heater 516 is arranged between the first 512 and second 514 heater casings. An airflow pathway (denoted by a plurality of arrows 522 in FIG. 7) extends through the heater assembly 510 from an air inlet 518 at a distal end of the first heater casing 512 to an aerosol outlet 520 at proximal end of the second heater casing 514 and passes through the first heater casing 512, the tubular heater 516 and the second heater casing 514.

Unlike the examples of FIGS. 2 and 4, the heater assembly 510 of FIG. 7 does not use O-rings as sealing elements to seal the first 512 and second 514 heater casings to the tubular heater 516. Instead, in the example of FIG. 7, the first 526 and second 524 sealing elements comprise opposing end sections 516c of the tubular heater 516, which end sections 516c are fixed in sealing engagement with an inner surface 512a of the first heater casing 512 and an inner surface 514a of the second heater casing 514 respectively.

The first 526 and second 524 sealing elements may be formed by fixing end sections 516c of the tubular heater 516 in sealing engagement within a grooves or trenches 512b and 514b, which extend circumferentially around the inner surface 512a of the first heater casing 512 and the inner surface 514a of the second heater casing 514 respectively. Alternatively, the first 524 and second sealing element 524 may be provided by forming the first 512 and second 514 heater casings around the end sections 516c of the tubular heater 516 or driving the end sections 516c of the tubular heater 516 into the first 512 and second 514 heater casings such that the end sections 516c are embedded in the inner surface 512a of the first heater casing 512 and the inner surface 514a of the second heater casing 514 respectively. The sealing engagement of the first 526 and second 524 sealing elements can be achieved by one or more of the following processes insert moulding, over moulding, hot-melting, high frequency welding and ultrasonic welding. It will be appreciated that other suitable processes may also be used.

The end sections 516c of the tubular heater 516 are elongated so that they can extend into the grooves or trenches 512b and 514b or into the inner surfaces 512a and 514a of the first 512 and second 514 heater casings respectively, whilst maintaining the same length of the tubular heater 516 between the first 512 and second 514 heater casings. The surfaces of the end sections 516c of the tubular heater 516 are roughened to have a surface finish with an ISO roughness value in the range N9 to N12 to help retain the end portions 516c in the grooves or trenches 512b and 514b or to help adhere the material of the first 512 and second 514 heater casings to the end portions 516c.

In the example heater assembly 510 of FIG. 7, the opposing end sections 516c are sealed within the first 512 and second 514 heater casings. The sealing engagement of the opposing end sections 516c of the tubular heater 516 with the grooves or trenches 512b and 514b or the inner surfaces of the first 512 and second 514 heater casings helps to seal the airflow pathway 522 and protect the opposing end sections 516c. Furthermore, the material of the first 512 and second 514 heater casings surrounding the end sections 516c acts as a physical barrier between the end sections 516c and the airflow pathway.

FIG. 8 is a side view of the tubular heater 516 from the heater assembly 510 of FIG. 7 showing the tubular heater 516 in more detail. The shape and size of the tubular heater 516 of FIG. 8 is substantially the same as the tubular heater 16 of FIG. 6 with the exception that the tubular heater 516 of FIG. 8 has elongated end sections 516c. The tubular heater 516 comprises a stainless steel tube having a circular cross-section. A portion 516a of the tubular heater 516 near each end of the tubular heater 516 is flared outwards to form a funnel shape at each end of the tubular heater 516. The flared end portions 516a of the tubular heater 516 each form an angle β with the longitudinal axis of the tubular heater 516. In this example, ß is approximately 45 degrees but other suitable angles may be used. As a result of the flared end portions 516a, the external diameter D at the two ends of the tubular heater 516 is larger than the external diameter d of the tubular heater 16 in between the two flared end portions 516a. The two end sections 516c of the tubular heater 516 are elongated and extend a distance 12 in a direction parallel to the longitudinal axis of the tubular heater 516. The percentage of the overall length l of the tubular heater 516 made up by each length l₂ of the end sections may be in the range between 5 and 15 percent. As described above, the surfaces of the end sections 516c of the tubular heater 516 are roughened to have a surface finish with an ISO roughness value in the range N9 to N12.

FIG. 9 is a cross-sectional view of a heater assembly 610 according to another example of the present disclosure. The heater assembly 610 of FIG. 9 is a combination of the sealing arrangements provided in the heater assemblies 410 and 510 of FIG. 4 and FIG. 7 respectively. The heater assembly 610 comprises a first heater casing 612, a second heater casing 614 and a tubular heater 616 for heating an aerosol-forming substrate received within the tubular heater 616. The tubular heater 616 is arranged between the inner surfaces of the first 612 and second 614 heater casings. A heater sleeve 630 is arranged between the opposing end surfaces of the first 612 and second 614 heater casings. The heater sleeve 630 circumferentially surrounds substantially the whole length of the tubular heater 616 except for the two ends of the tubular heater 616 which sit within the first 612 and second 614 heater casings. An airflow pathway (denoted by a plurality of arrows 622 in FIG. 9) extends through the heater assembly 610 from an air inlet 618 at a distal end of the first heater casing 612 to an aerosol outlet 620 at proximal end of the second heater casing 614 and passes through the first heater casing 612, the tubular heater 616 and the second heater casing 614.

Similar to the heater assembly 510 of FIG. 7, the heater assembly 610 of FIG. 9 has first 626 and second 624 sealing elements comprising opposing end sections 616c of the tubular heater 616, which end sections 616c are fixed in sealing engagement with an inner surface 612a of the first heater casing 612 and an inner surface 614a of the second heater casing 614 respectively.

The heater assembly 610 of FIG. 9 further comprises a third sealing element 632 and a fourth sealing element 634 to seal the tubular heater 616 to the first heater casing 612 and heater sleeve 630 and to seal the tubular heater 616 to the second heater casing 614 and heater sleeve 630 respectively. The third 632 and fourth 634 sealing elements are the same as the first 426 and second 424 sealing elements of the heater assembly 410 of FIG. 4.

The third sealing element 632 comprises an O-ring which circumscribes the tubular heater 616 near to a distal end of the tubular heater 616. The O-ring contacts an outer surface of the tubular heater 616, an inner surface of the first heater casing 612 and a distal end surface of the heater sleeve 630 to provide a seal between these components that inhibits the leakage of aerosol from the heater assembly 610 into surrounding parts of the aerosol-generating device (not shown).

The fourth sealing element 634 comprises an O-ring which circumscribes the tubular heater 616 near to a proximal end of the tubular heater 616. The O-ring contacts an outer surface of the tubular heater 616, an inner surface of the second heater casing 614 and a proximal end surface of the heater sleeve 630 to provide a seal between these components that inhibits the leakage of aerosol from the heater assembly 610 into surrounding parts of the aerosol-generating device (not shown).

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5 percent (5%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-21. (canceled)

22. A heater assembly for an aerosol-generating device, the heater assembly comprising:
a first heater casing comprising an air inlet;
a second heater casing comprising an aerosol outlet;
a tubular heater configured to heat an aerosol-forming substrate;
an airflow pathway extending through the heater assembly from the air inlet to the aerosol outlet, the airflow pathway passing through the first heater casing, the tubular heater, and the second heater casing;
a first sealing element configured to seal the first heater casing to the tubular heater; and
a second sealing element configured to seal the second heater casing to the tubular heater,
wherein the first and the second sealing elements are separated from the airflow pathway.

23. The heater assembly according to claim 22, wherein the first sealing element comprises an annular seal and is arranged between an inner surface of the first heater casing and an outer surface of the tubular heater.

24. The heater assembly according to claim 22, wherein the second sealing element comprises an annular seal and is arranged between an inner surface of the second heater casing and an outer surface of the tubular heater.

25. The heater assembly according to claim 22, wherein at least one of the first and the second sealing elements is arranged in a groove or recess formed in an inner surface of a respective one of the first and the second heater casings.

26. The heater assembly according to claim 22, wherein the first heater casing comprises a tube holder configured to hold the tubular heater, the airflow pathway passing through the tube holder.

27. The heater assembly according to claim 26, wherein the first sealing element is arranged between the tube holder and an outer surface of the tubular heater.

28. The heater assembly according to claim 22, wherein the first and the second sealing elements comprise opposing end sections of the tubular heater, the opposing end sections being fixed in sealing engagement to inner surfaces of the first and the second heater casings.

29. The heater assembly according to claim 28, wherein the opposing end sections of the tubular heater are fixed in sealing engagement within grooves or recesses formed in the inner surfaces of the first and the second heater casings.

30. The heater assembly according to claim 28, wherein the opposing end sections of the tubular heater are embedded in the inner surfaces of the first and the second heater casings.

31. The heater assembly according to claim 28, wherein the opposing end sections of the tubular heater have a surface finish with an ISO roughness value in a range of N9 to N12.

32. The heater assembly according to claim 28, further comprising:
a third sealing element configured to further seal the first heater casing to the tubular heater; and
a fourth sealing element configured to further seal the second heater casing to the tubular heater.

33. The heater assembly according to claim 32, wherein the third sealing element comprises an annular seal and is arranged between an inner surface of the first heater casing and an outer surface of the tubular heater.

34. The heater assembly according to claim 32, wherein the fourth sealing element comprises an annular seal and is arranged between an inner surface of the second heater casing and an outer surface of the tubular heater.

35. The heater assembly according to claim 22, wherein the tubular heater is enclosed by the first and the second heater casings.

36. The heater assembly according to claim 22, further comprising a heater sleeve surrounding at least a portion of the tubular heater, the heater sleeve being arranged between the first and the second heater casings.

37. The heater assembly according to claim 36, wherein the first sealing element engages an inner surface of the first heater casing, an outer surface of the tubular heater, and an inner or end surface of the heater sleeve.

38. The heater assembly according to claim 36, wherein the second sealing element engages an inner surface of the second heater casing, an outer surface of the tubular heater, and an inner or end surface of the heater sleeve.

39. The heater assembly according to claim 22, wherein a diameter of the tubular heater at each end of the tubular heater is greater than a diameter of the tubular heater in a region between the two ends of the tubular heater.

40. The heater assembly according to claim 39, wherein a portion of each end of the tubular heater is flared or funnel-shaped.

41. An aerosol-generating device, comprising:
a heater assembly according to claim 22; and
a power supply for supplying electrical power to the heater assembly.
